(19) United States
(12) Patent Application Publication
(10) Pub. No.: US 2003/0221526 A1
(43) Pub. Date: Dec. 4, 2003

(54) Boring bar holder for CNCand related devices

(76) Inventor: Robert L. Morson, Houston, TX (US)

Correspondence Address: Alton W. Payne, Suite 200, 5001 Bissonnet, Bellaire, TX, 77401, US

(21) Appl. No.: 10/104,344

(22) Filed: Jun. 3, 2002

(51) Int. Cl. B23B 7/00; B23B 9/00

(52) U.S. Cl. 82/158

(57) ABSTRACT

A boring bar holder is provided. The boring bar holder is for use with a computer numerically controlled (CNC) machine. The boring bar holder has a base block assembly, the base block assembly has a first end and a second end, and between the ends, a semibore transverses one side of the base block assembly, a top or second block assembly, the top or second block assembly has a first end and a second end, and between the ends, a semibore transverses one side of the top or second block assembly, and at least one securing member disposed on each side of the semibores in each block assembly for securing the base block assembly to the top or second block assembly and the block assembly to the CNC machine, such that a bar engaged between the blocks in the bore is engaged with a precise, constant pressure and compression for securing the bar in the boring bar holder. In yet another embodiment, a center gage block is provided for use with a computer numerically controlled (CNC) machine having a boring bar holder with a notch under the tool or bar to be held. The center gage block comprises a box portion having a flat top, a protrusion extending from the boxed portion such that the protrusion also has a flat top, such that the protrusion is sized to be accepted into and secured by the notch in the boring bar holder with the centered gage block providing for the alignment of a flat portion of a bar-member which is secured by the boring bar holder and after the bar or tool is aligned, the center gage block can be removed from the notch in the boring block holder, thus, providing for accurate and speeding alignment of all bar-members by the boring bar holder of the present invention.

### FIELD OF THE INVENTION

The present invention relates generally to computer numerically controlled (CNC) machine tools such as a CNC lathe. More particularly, the present invention relates to a boring bar holder, and associated methods.

### BACKGROUND OF THE INVENTION

Machine tools such as a CNC lathe include at least one cutting tool, at least one rotatable holder for a blank, and at least one CNC device for controlling the cutting of the blank according to selected specification. The CNC machine tool may include a multi-axis, linear (X, Y axis) holder instead of a rotatable holder. In either case, a cutting tool moves relative to the blank or work piece under the control of a programmable controller, including a computer program.

The holding of the cutting tool or bar is a problem. The CNC machines hold the cutting tool or bar with a sleeve-type device. The cutting tool or bar is removably secured in the sleeve-type device by screws with countersunk heads or the like. Using these methods of securing the cutting tool or bar causes many problems. For example, during use the cutting tool or bar causes chatter. Also, the use of the cutting tool or bar causes vibration which is very undesirable for accurate reproduction of the desired part.

Further, the typical holding of the cutting tool or bar causes cantilevering. Also, such prior art devices are very difficult to align the cutting tool or bar in the sleeve-type holder. It is difficult to accurately align the cutting tool or bar in the sleeve-type holder. Thus, to achieve proper alignment takes much time and effort.

Still further, not having a sufficiently secured cutting tool or bar reduces the surface feed for the machine. Surface feed is the amount of metal taken off per unit time. Also, not having a sufficiently secured cutting tool or bar reduces production time.

There exists a need for an improved boring bar holder. There exists a need for a boring bar holder that reduces chatter. Further, there exists a need for a boring bar holder that eliminates or reduces vibration. Also, there exists a need for a boring bar holder that more accurately reproduces the desired part. Still further, there exists a need for a boring bar holder that prevents cantilevering. Still further, there exists a need for a boring bar holder that enhances the alignment of the cutting tool or bar. Yet still further, there exists a need for a boring bar holder that increases the surface feed for any machine. And still further, there exists a need for a boring bar holder that decreases production time.

It is, therefore, a feature of the present invention to provide a boring bar holder for use with a computer numerically controlled (CNC) machine or the like that increases the efficiency of the CNC machine.

A feature of the present invention is to provide a boring bar holder for use with a computer numerically controlled (CNC) machine or the like that reduces chatter.

Another feature of the present invention is to provide a boring bar holder for use with a computer numerically controlled (CNC) machine or the like that eliminates or reduces vibration.

Yet still another feature of the present invention is to provide a boring bar holder for use with a computer numerically controlled (CNC) machine or the like that more accurately reproduces the desired part.

Yet further, an additional feature of the present invention is to provide a boring bar holder for use with a computer numerically controlled (CNC) machine or the like that prevents cantilevering.

Yet still further, an additional feature of the present invention is to provide a boring bar holder for use with a computer numerically controlled (CNC) machine or the like that enhances the alignment of the cutting tool or bar.

Yet still further, an additional feature of the present invention is to provide a boring bar holder for use with a computer numerically controlled (CNC) machine or the like that increases the surface feed for any machine.

Yet still further, an additional feature of the present invention is to provide a boring bar holder for use with a computer numerically controlled (CNC) machine or the like that decreases production time.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

To achieve the foregoing objects, features, and advantages and in accordance with the purpose of the invention as embodied and broadly described herein, a boring bar holder is provided. The boring bar holder is for use with a computer numerically controlled (CNC) machine. The boring bar holder has a base block assembly, the base block assembly has a first end and a second end, and between the ends, a semibore transverses one side of the base block assembly, a top or second block assembly, the top or second block assembly has a first end and a second end, and between the ends, a semibore transverses one side of the top or second block assembly, and at least one securing member disposed on each side of the semibores in each block assembly for securing the base block assembly to the top or second block assembly and the block assembly to the CNC machine, such that a bar engaged between the blocks in the bore is engaged with a precise, constant pressure and compression for securing the bar in the boring bar holder.

In another embodiment, the boring bar holder for use with a computer numerically controlled (CNC) machine comprising (a) a base block assembly, the base block assembly has a first end and a second end, and between the ends, a semibore transverses one side of the base block assembly, (b) a top or second block assembly, the top or second block assembly has a first end and a second end, and between the ends, a semibore transverses one side of the top or second block assembly, (c) at least one securing member disposed on each side of the semibore in each block assembly for securing the base block assembly to the top or second block assembly and the block assembly to the CNC machine, such that a bar engaged between the blocks in the semibores is engaged with a precise, constant pressure and compression for securing the bar in the boring bar holder, and (d) a center gage block having a box portion with a flat top and a protrusion extending from the boxed portion such that the protrusion also has a flat top such that the protrusion is sized to be accepted into and secured by the notch in the boring bar holder with the center gage block providing for the alignment of a flat portion of a bar-member which is secured by the boring bar holder and after the bar or tool is aligned, the center gage block can be removed from the notch in the boring block holder, thus, providing for accurate and faster alignment of all bar-members by the boring bar holder of the present invention.

In yet another embodiment, a center gage block is provided for use with a computer numerically controlled (CNC) machine having a boring bar holder with a notch under the tool or bar to be held. The center gage block comprises a box portion having a flat top, a protrusion extending from the boxed portion such that the protrusion also has a flat top, such that the protrusion is sized to be accepted into and secured by the notch in the boring bar holder with the center gage block providing for the alignment of a flat portion of a bar-member which is secured by the boring bar holder and after the bar or tool is aligned, the center gage block can be removed from the notch in the boring block holder, thus, providing for accurate and speeding alignment of all bar-members by the boring bar holder of the present invention.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a perspective view of the boring bar holder of the present invention.

FIG. 2. is a perspective view of the base block assembly of the boring bar holder of the present invention.

FIG. 3 is an end view of the base block assembly of illustrate in third view of the boring bar holder of the present invention.

FIG. 4 is an end view of the base block assembly of the boring bar holder of the present invention.

FIG. 5 is a plan view/bottom view of the base block assembly of the boring bar holder of the present invention showing the semibores.

FIG. 6 is a figure illustrating the appropriate sizing characteristics for the boring bar holder of the present invention.

Table 1 lists specifications for the sizing of the boring bar holder of present invention.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

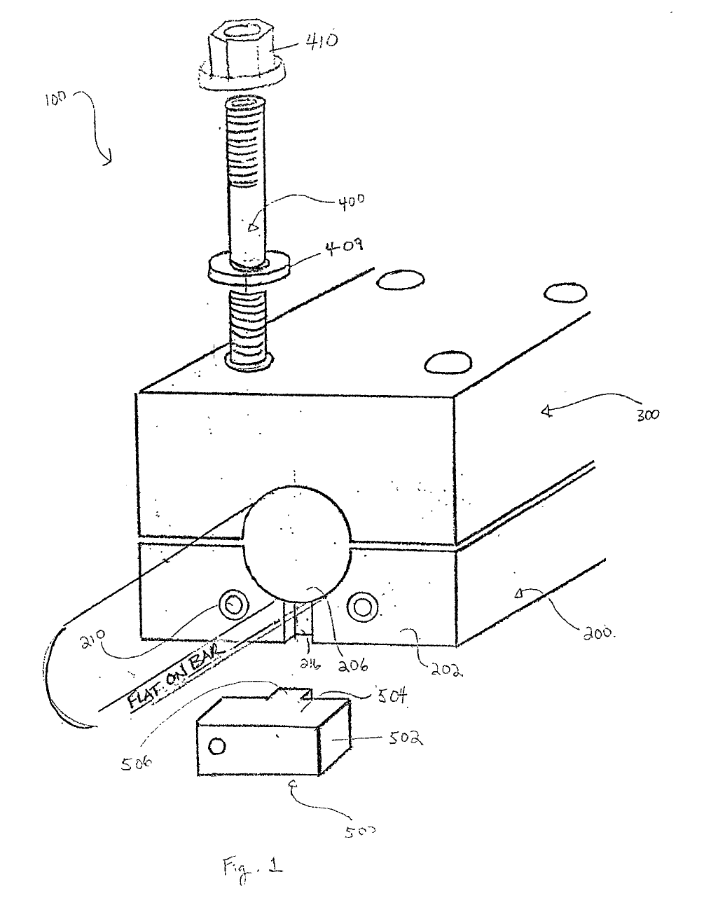

FIG. 1 is a perspective view of the boring bar holder 100 of the present invention. FIG. 1 illustrates the base block assembly 200 engaged with the top or second block assembly 300. The base and top or second block assemblies 200, 300 are removeably engaged with each other using one or more securing members 400. The securing members 400 are shown having a first end 402 with a threaded portion 404. Also, the securing members or studs 400 have a second end 406 with a threaded portion 408. A washer 409 is disposed between the top or second block assembly 300 and a tightening member or flange hex nut 410. The center gage block 500 engages the base block assembly 200 for aligning a flat portion of a bar that is secured by the boring bar holder 100.

The center gage block 500 comprises a boxed portion 502 with a flat top 504. The centered gage block 500 also has a protrusion 506 extending from the side of the boxed portion 502. The protrusion 506 is sized to be accepted into and secured by the notch 216 in the base block assembly 200 of the boring block holder 100.

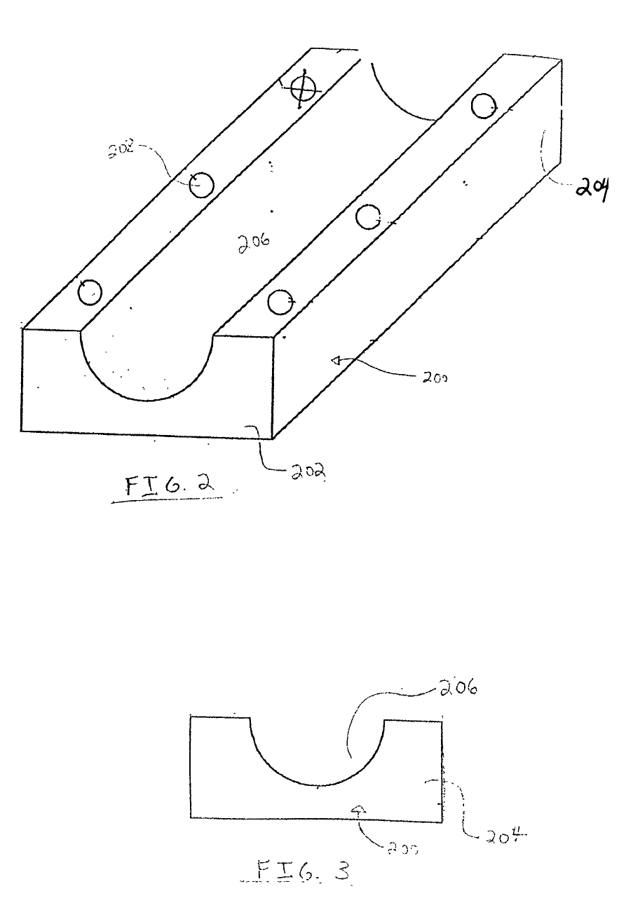

FIG. 2 is a perspective view of the base block assembly 200 of the boring bar holder 100 of the present invention. The base block assembly 200 has a first end 202 and a second end 204. Between the ends 202, 204, a semibore 206 transverses one side of the base block assembly 200. The semibore 206 comprises or has the shape of a half cylinder. The base block assembly 200 has at least one aperture 208 disposed on both sides of the semibore 206. Also, the base block assembly 200 has at least one water channel 210 traversing a portion of the base block assembly 200 as seen in FIG. 1.

FIG. 3 is and end view of the base block assembly 200 as illustrated in FIG. 2. The second end 204 of the base block assembly 200 is illustrated with the semibore 206 illustrated by a concaved member.

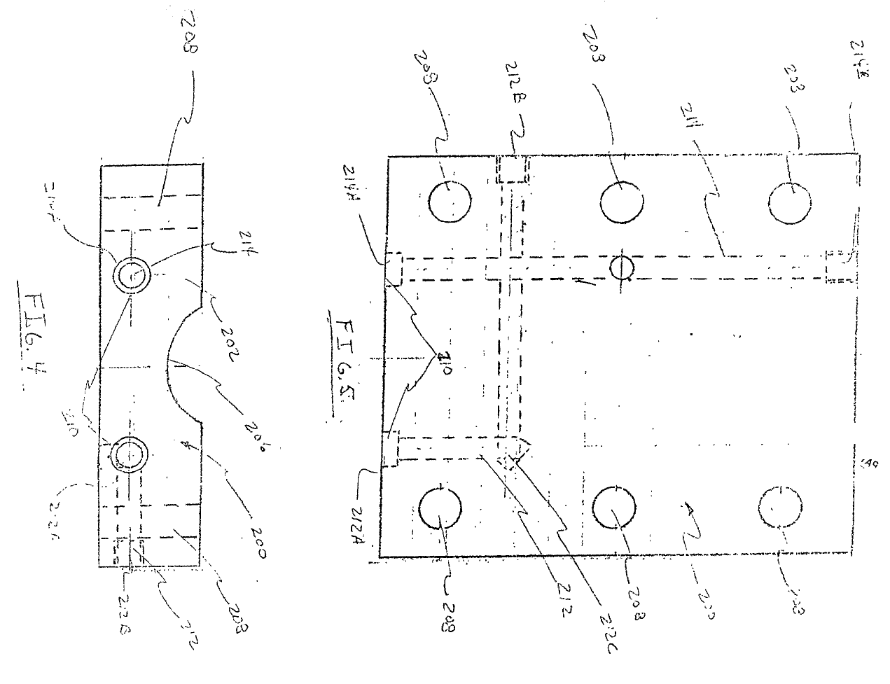

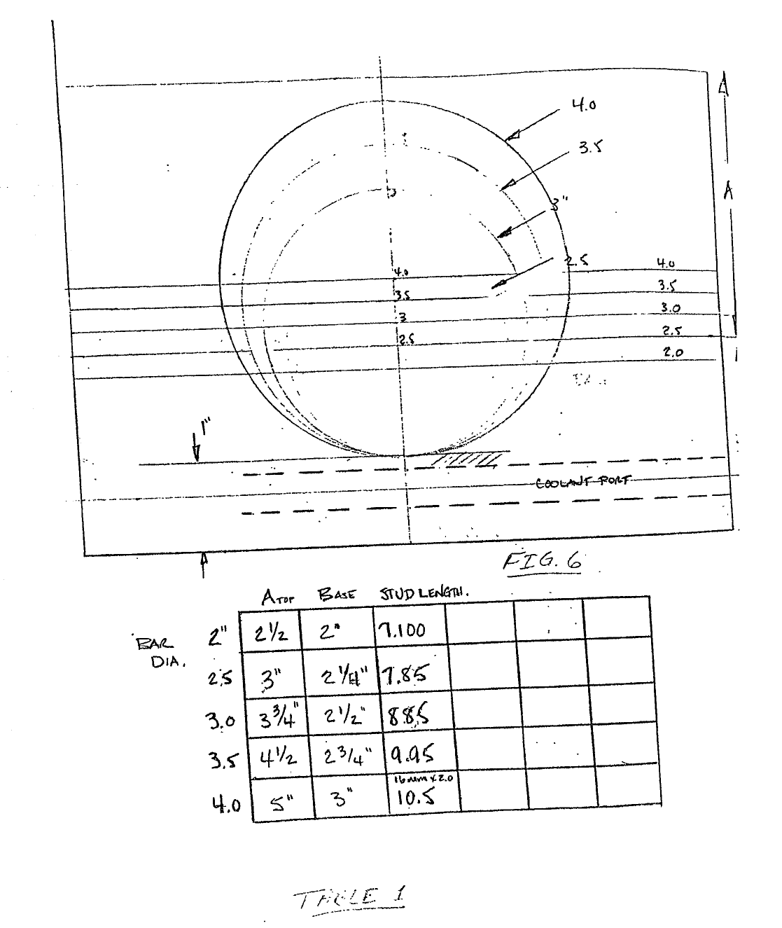

FIGS. 4 and 5 are an end view of the base block assembly 200 of the boring bar holder 100 of the present invention illustrating the first end 202 and a plan view/bottom view of the base block assembly 202 of the boring bar holder 100 of the present invention showing the semibores, respectively. The first end 202 is illustrated having two apertures 212A, 214A. The first aperture 212A is the entry point for an L-shaped water channel 212. The L-shaped water channel 212 has the aperture 212A on the first end 202 and an aperture 212B on the second end 204 as well as an angle portion 212C. The other water channel 210 comprises a straight water channel 214. The straight water channel 214 has apertures 214A in the first end 202 and an aperture 214B in the second end 204 of the base block assembly 200.

As illustrated in FIG. 1, the notch 216 is disposed between the apertures 214A, 212A of the water channels 212, 214 and at the center of the curvature of the half cylinder of the semibore 206. The use and efficacy of the notch 216 will be discussed in detail herein.

The top or second block assembly 300 has a first end 302 and a second end 304. Disposed between the first and second ends 302, 304 is a semibore 306. The semibore 306 provides a half cylinder shaped into the body of the top or second block assembly 300. The top or second block assembly 300 has at least one aperture 308 disposed on both sides of the semibore 306 of the top or second block assembly 300.

The securing members or studs 400 have a first end 402 with a threaded portion 404, and a second end 406 with a threaded portion 408. A tightening member or flange hex nut 410 provides for securing the studs 400 to the boring bar holder 100. A washer 409 is disposed between tightening member or flange hex nut 410 and the top or second block assembly 300. The securing members or studs 400 provide for precision securing of the base block assembly 200 with the top or second block assembly 300 such that a precise pressure can be placed against any tool placed in the boring bar holder 100 of the present invention. The precise and constant pressure against the gripped tool provides for enhanced securement of the tool in the boring bar holder 100 of the present invention.

The center gage block 500 comprises a box portion 502. The box portion 502 has a flat top 504. Also, the center gage block 500 has a protrusion 506 extending from the boxed portion 502. The protrusion 506 also has a flat top. The protrusion 506 is sized to be accepted into and secured by the notch 216 in the base block assembly 200. The centered gage block 500 provides for aligning the flat portion of a bar-member or tool which is secured by the boring bar holder 100. After the bar or tool is aligned, the center gage block 500 can be removed from the notch 216 and the base block assembly 200. Thus, providing for accurate and speeding alignment of all bars by the boring bar holder 100 of the present invention.

Additional advantages and modification will readily occur to those skilled in the art. The invention in its broader aspects is therefore not limited to the specific details, representative apparatus, and the illustrative examples shown and described herein. Accordingly, departures may be made from the details without departing from the spirit or scope of the disclosed general inventive concept.

What is claimed is:

1. A boring bar holder for use with a computer numerically controlled (CNC) machine comprising:
(a) a base block assembly, the base block assembly has a first end and a second end, and between the ends, a semibore transverses one side of the base block assembly,
(b) a second block assembly, the second block assembly has a first end and a second end, and between the ends, a semibore transverses one side of the second block assembly, and
(c) at least one securing member disposed on each side of the semibores in each block assembly for securing the base block assembly to the second block assembly and the block assembly to the CNC machine, such that a bar engaged between the blocks in the bore is engaged with a precise, constant pressure and compression for securing the bar in the boring bar holder.

2. The boring bar holder for use with a computer numerically controlled (CNC) machine as defined in claim 1 wherein the base block assembly further comprises at least one cooling channel.

3. The boring bar holder for use with a computer numerically controlled (CNC) machine as defined in claim 1 wherein the securing members further comprise threaded studs.

4. The boring bar holder for use with a computer numerically controlled (CNC) machine as defined in claim 1 further comprising a center gage block.

5. The boring bar holder for use with a computer numerically controlled (CNC) machine as defined in claim 1 wherein the center gage block comprises a box portion having a flat top and a protrusion extending from the boxed portion such that the protrusion also has a flat top.

6. A center gage block for use with a computer numerically controlled (CNC) machine having a boring bar holder with a notch under the tool or bar to be held, the center gage block comprising:
(a) a box portion having a flat top,
(b) a protrusion extending from the boxed portion such that the protrusion also has a flat top,
such that the protrusion is sized to be accepted into and secured by the notch in the boring bar holder with the centered gage block providing for the alignment of a flat portion of a bar-member which is secured by the boring bar holder and after the at least one of bar and tool is aligned, the center gage block can be removed from the notch in the boring block holder, thus, providing for accurate and speeding alignment of all bar-members by the boring bar holder of the present invention.

7. A boring bar holder for use with a computer numerically controlled (CNC) machine comprising:
(a) a base block assembly, the base block assembly has a first end and a second end, and between the ends, a semibore transverses one side of the base block assembly,
(b) a second block assembly, the second block assembly has a first end and a second end, and between the ends, a semibore transverses one side of the second block assembly, and
(c) at least one securing member disposed on each side of the semibores in each block assembly for securing the base block assembly to the second block assembly and the block assembly to the CNC machine, such that a bar engaged between the blocks within the semibores is engaged with a precise, constant pressure and compression for securing the bar in the boring bar holder, and
(d) a center gage block having a box portion with a flat top and a protrusion extending from the boxed portion such that the protrusion also has a flat top.

8. The boring bar holder for use with a computer numerically controlled (CNC) machine as defined in claim 7 wherein the center gage block further comprises that the protrusion is sized to be accepted into and secured by the notch in the boring bar holder with the centered gage block providing for the alignment of a flat portion of a bar-member which is secured by the boring bar holder and after the at least one of bar and tool is aligned, the center gage block can be removed from the notch in the boring block holder, thus, providing for accurate and speeding alignment of all bar-members by the boring bar holder of the present invention.

9. A boring bar holder for use with a computer numerically controlled (CNC) machine comprising:
(a) a base block assembly, the base block assembly has a first end and a second end, and between the ends, a semibore transverses one side of the base block assembly,
(b) a second block assembly, the second block assembly has a first end and a second end, and between the ends, a semibore transverses one side of the second block assembly, and
(c) at least one securing member disposed on each side of the semibores in each block assembly for securing the base block assembly to the second block assembly and the block assembly to the CNC machine, such that a bar engaged between the blocks in the semibores is engaged with a precise, constant pressure and compression for securing the bar in the boring bar holder, and
(d) a center gage block having a box portion with a flat top and a protrusion extending from the boxed portion such that the protrusion also has a flat top such that the protrusion is sized to be accepted into and secured by the notch in the boring bar holder with the centered gage block providing for the alignment of a flat portion of a bar-member which is secured by the boring bar holder and after at least one of the bar and tool is aligned, the center gage block can be removed from the notch in the boring block holder, thus, providing for accurate and speeding alignment of all bar-members by the boring bar holder of the present invention.
